(19) United States
(12) Patent Application Publication
(10) Pub. No.: US 2012/0125593 A1
(43) Pub. Date: May 24, 2012

(54) COOLING SYSTEM FOR VEHICLE

(75) Inventors: Nobuharu Kakehashi, Toyoake-city (JP); Nobuyuki Hashimura, Tokai-city (JP)

(73) Assignee: DENSO CORPORATION, Kariya-city (JP)

(21) Appl. No.: 13/296,564

(22) Filed: Nov. 15, 2011

(30) Foreign Application Priority Data
Nov. 23, 2010 (JP) 2010-260701

(51) Int. Cl. G05D 23/00

(52) U.S. Cl. 165/287

(57) ABSTRACT

A cooler cools electric parts of a vehicle using heat medium. A radiator emits heat of the heat medium to air, and a valve changes a flow of the heat medium based on a temperature of the heat medium. The valve controls the heat medium to bypass the radiator when the temperature of the heat medium is lower than a first predetermined value. The valve controls the heat medium to flow through the radiator when the temperature of the heat medium is higher than or equal to the first predetermined value.

### CROSS REFERENCE TO RELATED APPLICATION

This application is based on Japanese Patent Application No. 2010-260701 filed on Nov. 23, 2010, the disclosure of which is incorporated herein by reference in its entirety.

### BACKGROUND OF THE INVENTION

1. Field of the Invention

The present invention relates to a cooling system for a vehicle.

2. Description of Related Art

JP-2006-103537A describes a cooling system for a hybrid vehicle in which a cooling system of engine and a cooling system of hybrid apparatus are unified so as to reduce the number of components included in the cooling system. Thus, the cooling system is simplified and made smaller, and manufacture cost of the cooling system is reduced.

Specifically, the cooling system has a first passage and a second passage connected in parallel with each other. An engine of the vehicle is arranged in the first passage, and an inverter unit and a generator of the vehicle are arranged in the second passage. The engine corresponds to an energy generator of the vehicle, and the inverter unit and the generator correspond to electric parts of the vehicle.

Generally, a hybrid vehicle has high fuel efficiency. However, heat source tends to be shorted in the hybrid vehicle, because an amount of waste heat emitted from an engine of the hybrid vehicle is small. It may be necessary to operate the engine to increase the heat source in cold season, and the operation of the engine lowers the fuel efficiency. JP-2006-103537A fails to teach the heating properties.

The disadvantage is generated not only in the hybrid vehicle but also in a fuel cell vehicle that uses a fuel cell as an energy generator for driving the vehicle. Waste heat emitted from the fuel cell is used for heating in the fuel cell vehicle. However, an amount of waste heat emitted from the fuel cell is small, so that heat source is shorted. If supplementary heating equipment such as an electric heater is used, the fuel efficiency becomes lower.

### SUMMARY OF THE INVENTION

In view of the foregoing and other problems, it is an object of the present invention to raise the heating properties without worsening the fuel efficiency.

According to an example of the present invention, a cooling system fore vehicle includes a circulator that circulates heat medium, which cools an energy generator for driving the vehicle, in a heat medium circuit; a cooler that cools electric parts of the vehicle using the heat medium; a radiator that emits heat of the heat medium to air; a heat exchanger that heats air to be sent into a passenger compartment of the vehicle by exchanging heat with the heat medium; and a valve that changes a flow of the heat medium among a plurality of modes based on a temperature of the heat medium. The plurality of modes include a radiator bypass mode where the heat medium flows by bypassing the radiator and a radiator flow mode where the heat medium flows through the radiator. The valve changes the flow of the heat medium to have the radiator bypass mode when the temperature of the heat medium does not reach a first predetermined value. The valve changes the flow of the heat medium to have the radiator flow mode when the temperature of the heat medium reaches the first predetermined value.

Accordingly, the heating properties can be raised without worsening the fuel efficiency.

### BRIEF DESCRIPTION OF THE DRAWINGS

The above and other objects, features and advantages of the present invention will become more apparent from the following detailed description made with reference to the accompanying drawings. In the drawings:

FIG. 1 is a circuit diagram illustrating a cooling system according to a first embodiment;

FIG. 2A is a circuit diagram illustrating a first mode of the cooling system,

FIG. 2B is a circuit diagram illustrating a second mode of the cooling system, and

FIG. 2C is a circuit diagram illustrating a third mode of the cooling system;

FIG. 3 is a circuit diagram illustrating a cooling system according to a second embodiment;

FIG. 4 is a circuit diagram illustrating a cooling system according to a third embodiment;

FIG. 5 is a circuit diagram illustrating a cooling system according to a fourth embodiment;

FIG. 6 is a circuit diagram illustrating a cooling system according to a fifth embodiment;

FIG. 7A is a schematic cross-sectional view illustrating a first radiator and a second radiator of a cooling system according to a sixth embodiment, FIG. 7B is a schematic perspective view illustrating a corrugated fin for the first radiator and the second radiator, and FIG. 7C is a schematic perspective view illustrating a modification example of the corrugated fin; and

FIG. 8 is a circuit diagram illustrating a cooling system according to a seventh embodiment.

### DETAILED DESCRIPTION OF PREFERRED EMBODIMENT

### First Embodiment

In a first embodiment, a cooling system is applied to a hybrid vehicle that obtains driving force from a combustion engine and an electric motor.

Specifically, the hybrid vehicle has a water-cooled type engine and an electric motor, and the driving force is transmitted to drive wheels of the vehicle through a transmission. The electric motor receives electricity from a secondary battery through an inverter. The inverter converts direct-current voltage into alternating-current voltage and varies frequency of the alternating-current voltage so that rotational speed of the motor is controlled.

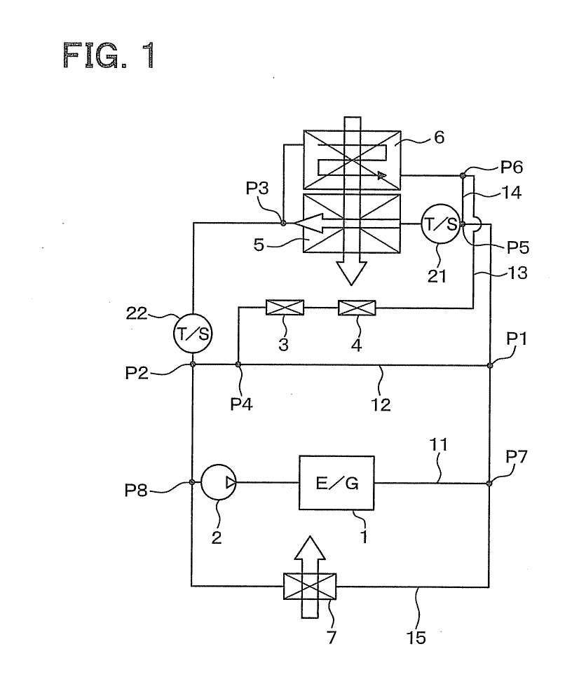

The cooling system is configured to cool an engine 1, a motor generator (not shown in FIG. 1) and an inverter (not shown in FIG. 1) using cooling water. The engine 1 corresponds to energy generator or power source for driving the vehicle. The motor generator corresponds to an electric motor. The cooling water corresponds to heat medium. The motor generator and the inverter are examples of electric parts of the vehicle, and generate heat at the time of operation. However, the electric parts are not limited to the motor generator and the inverter.

As shown in FIG. 1, a water pump 2, a first heat exchanger 3 for the motor generator, a second heat exchanger 4 for the inverter, a first radiator 5, a second radiator 6, and a heater core 7 are arranged in a cooling water circuit of the cooling system.

The water pump 2 is a cooling water circulator that circulates cooling water (heat medium) in the cooling water circuit. For example, an electric pump is used as the water pump 2. A rotation number of the water pump 2 is controlled by a control voltage output from a controller (not shown), so that a circulation amount of the cooling water is controlled.

The first heat exchanger 3 cools the motor generator corresponding to electric parts. The second heat exchanger 4 cools the inverter corresponding to electric parts.

Heat of the cooling water is emitted to air by the first radiator 5 and the second radiator 6. The heater core 7 is a heat exchanger for heating air in an air-conditioner. Air to be sent into a passenger compartment of the vehicle is heated by the heater core 7 by exchanging heat with the cooling water.

The cooling water circuit has a circulation passage 11, a branch passage 12, a cooling passage 13, a bypass passage 14, and a heating passage 15.

The water pump 2, the engine 1, and the first radiator 5 are arranged in the circulation passage 11, in this order. The circulation passage 11 is constructed in a manner that cooling water discharged from the water pump 2 passes the engine 1 and the first radiator 5 in this order. Then, the cooling water is drawn into the water pump 2 again.

The branch passage 12 connects a branch point P1 to a confluent point P2 in the circulation passage 11. The branch point P1 is defined between the engine 1 and the first radiator 5. The confluent point P2 is defined between the first radiator 5 and the water pump 2.

The cooling passage 13 connects a branch point P3 in the circulation passage 11 to a confluent point P4 in the branch passage 12. The branch point P3 is defined between the first radiator 5 and the confluent point P2.

In the cooling passage 13, the second radiator 6, the second heat exchanger 4, and the first heat exchanger 3 are arranged in this order toward the confluent point P4 from the branch point P3.

The second radiator 6 is arranged at upstream of the first radiator 5 in air flowing direction. Therefore, air passing through the second radiator 6 flows into the first radiator 5.

The bypass passage 14 connects a branch point P5 in the circulation passage 11 to a confluent point P6 in the cooling passage 13. The branch point P5 is defined between the branch point P1 and the first radiator 5. The confluent point P6 is defined between the second radiator 6 and the second heat exchanger 4.

The heating passage 15 connects a branch point P7 to a confluent point P8 in the circulation passage 11. The branch point P7 is defined between the engine 1 and the branch point P1. The confluent point P8 is defined between the confluent point P2 and the water pump 2. The heater core 7 is arranged in the heating passage 15.

A first thermostat 21 corresponding to a first valve is arranged at the branch point P5 of the circulation passage 11. Although the thermostat 21 is illustrated near the branch point P5 in FIG. 1, the thermostat 21 is arranged actually at the branch point P5.

When a temperature of the cooling water flowing out of the engine 1 does not reach a first predetermined temperature (for example, about 50-70° C.) necessary for heating the passenger compartment, the first thermostat 21 closes the passage 11 between the branch point P5 and the first radiator 5, and opens the bypass passage 14.

When the temperature of the cooling water flowing out of the engine 1 reaches the predetermined temperature, the first thermostat 21 opens the passage 11 between the branch point P5 and the first radiator 5, and closes the bypass passage 14.

That is, when the temperature of the cooling water flowing out of the engine 1 is lower than 55° C., for example, the first thermostat 21 closes the passage 11 between the branch point P5 and the first radiator 5, and opens the bypass passage 14.

When the temperature of the cooling water flowing out of the engine 1 exceeds 55° C., the first thermostat 21 opens the passage 11 between the branch point P5 and the first radiator 5, and closes the bypass passage 14.

A second thermostat 22 corresponding to a second valve is arranged near the confluent point P2 of the circulation passage 11.

In a case where the cooling of the engine 1 is necessary, when the temperature of the cooling water does not reach a second predetermined temperature (for example, about 80-100° C.), the second thermostat 22 closes the passage 11 between the branch point P3 and the confluent point P2.

In the case where the cooling of the engine 1 is necessary, when the temperature of the cooling water reaches the second predetermined temperature, the second thermostat 22 opens the passage 11 between the branch point P3 and the confluent point P2.

That is, when the temperature of the cooling water is lower than 85° C., the second thermostat 22 closes the passage 11 between the branch point P3 and the confluent point P2.

When the temperature of the cooling water exceeds 85° C., the second thermostat 22 opens the passage 11 between the branch point P3 and the confluent point P2.

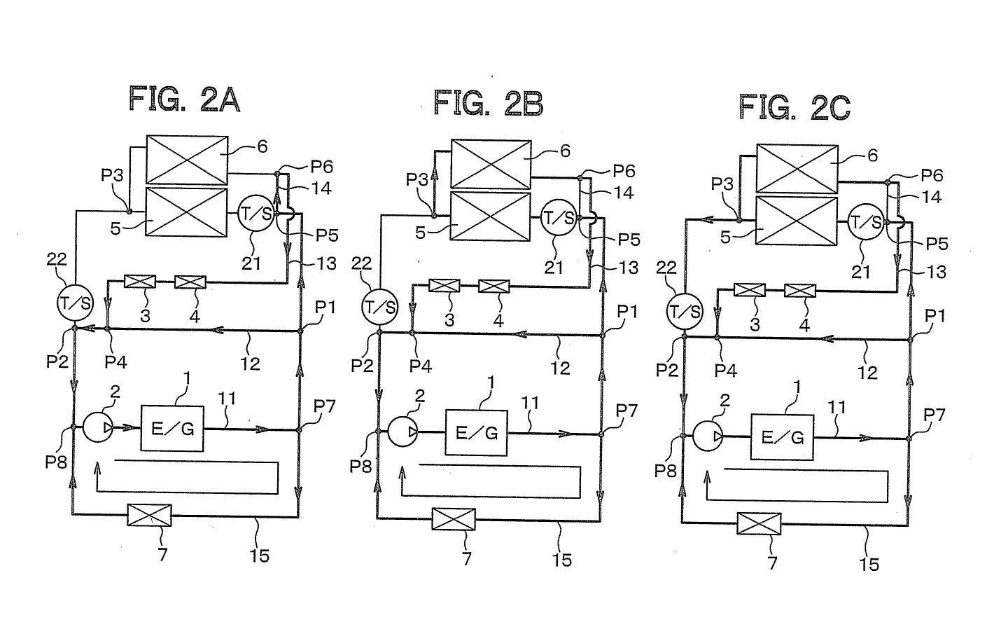

FIGS. 2A, 2B, and 2C show flow modes of the cooling water, and the flow modes are switched from each other by the first thermostat. 21 and the second thermostat 22. A first mode is shown in FIG. 2A. A second mode is shown in FIG. 2B. A third mode is shown in FIG. 2C. A flow of the cooling water is shown in bold line in FIGS. 2A, 2B, and 2C.

In the first mode, as shown in FIG. 2A, the first thermostat 21 closes the passage 11 adjacent to the first radiator 5 and opens the bypass passage 14, and the second thermostat 22 closes the passage 11 between the branch point P3 and the confluent point P2.

In the second mode, as shown in FIG. 2B, the first thermostat 21 opens the passage 11 adjacent to the first radiator 5 and closes the bypass passage 14, and the second thermostat 22 closes the passage 11 between the branch point P3 and the confluent point P2.

In the third mode, as shown in FIG. 2C, the first thermostat 21 opens the passage 11 adjacent to the first radiator 5 and closes the bypass passage 14, and the second thermostat 22 opens the passage 11 between the branch point P3 and the confluent point P2.

That is, the first mode is a low temperature mode set in a low temperature area where the temperature of the cooling water is lower than the first predetermined temperature such as 55° C.

The second mode is a middle temperature mode set in a middle temperature area such as 55-85° C. where the temperature of the cooling water is equal to or higher than the first predetermined temperature and is lower than the second predetermined temperature.

The third mode is a high temperature mode set in a high temperature area where the temperature of the cooling water is equal to or higher than the second predetermined temperature such as 85° C.

In the first mode, cooling water flows by bypassing the first radiator 5 and the second radiator 6. In the second mode and the third mode, cooling water flows through the first radiator 5 and the second radiator 6.

The first mode may correspond to a radiator bypass mode. The second mode and the third mode may correspond to a radiator flow mode.

A flow amount of the cooling water flowing through the first radiator 5 is smaller in the second mode compared with the third mode, and its reason will be described below. As a result, heat emitting amount in the first radiator 5 also decreases in the second mode compared with the third mode. The second mode can also be expressed as a low flow rate mode or low radiation mode.

That is, the flow amount of the cooling water flowing through the first radiator 5 is higher in the third mode compared with the second mode. The heat emitting amount in the first radiator 5 also increases in the third mode compared with the second mode. The third mode can also be expressed as a high flow rate mode or high radiation mode.

Flow of the cooling water in the first mode is explained specifically with reference to FIG. 2A. In the first mode, the flow of the cooling water flowing out of the water pump 2 passes the engine 1 in the circulation passage 11, and is branched at the branch point P7 into a flow heading to the branch point P1 in the circulation passage 11 and a flow flowing into the heating passage 15.

The cooling water flowing through the circulation passage 11 is further branched at the branch point P1 into a flow heading to the branch point P5 in the circulation passage 11 and a flow flowing through the branch passage 12.

The cooling water flowing through the circulation passage 11 flows into the bypass passage 14 at the branch point P5. That is, cooling water flows into the bypass passage 14 without flowing into the first radiator 5, because the first thermostat 21 closes the passage 11 between the branch point P5 and the first radiator 5 and because the first thermostat 21 opens the bypass passage 14.

After the cooling water flowing into the bypass passage 14 flows into the cooling passage 13 at the confluent point P6, the cooling water passes through the heat exchangers 4, 3, and flows into the branch passage 12 at the confluent point P4.

The cooling water flowing into the branch passage 12 at the confluent point P4 flows into the circulation passage 11 at the confluent point P2, and is drawn by the water pump 2 through the confluent point P8. That is, the cooling water flowing into the circulation passage 11 at the confluent point P2 flows toward the confluent point P8, without going to the branch point P3, because the second thermostat 22 closes the passage 11 between the branch point P3 and the confluent point P2.

On the other hand, the cooling water flowing into the branch passage 12 at the branch point P1 joins the cooling water flowing from the cooling passage 13 at the confluent point P4, and is drawn by the water pump 2 through the confluent points P2, P8.

On the other hand, the cooling water flowing into the heating passage 15 at the branch point P7 passes the heater core 7, joins the cooling water flowing through the circulation passage 11 at the confluent point P8, and is drawn by the water pump 2.

Thus, in the first mode, because the cooling water bypasses the first radiator 5 and the second radiator 6, heat is not radiated from the first radiator 5 and the second radiator 6. Therefore, when the temperature of the cooling water is low even while the passenger compartment is heated, waste heat of the electric parts obtained in the heat exchangers 4, 3 can be efficiently used for the heating of the passenger compartment at the heater core 7. Moreover, the waste heat of the electric parts can be efficiently used also for warming-up of the engine 1.

Flow of the cooling water in the second mode is explained specifically with reference to FIG. 2B. In the second mode, the flow of the cooling water flowing out of the water pump 2 passes the engine 1 in the circulation passage 11, and is branched at the branch point P7 into a flow heading to the branch point P1 in the circulation passage 11 and a flow flowing into the heating passage 15.

The cooling water flowing through the circulation passage 11 is further branched at the branch point P1 into a flow heading to the branch point P5 in the circulation passage 11 and a flow flowing through the branch passage 12.

The cooling water flowing through the circulation passage 11 flows into the first radiator 5 at the branch point P5. That is, cooling water flows into the first radiator 5 without flowing into the bypass passage 14, because the first thermostat 21 opens the passage 11 between the branch point P5 and the first radiator 5 and because the first thermostat 21 closes the bypass passage 14.

The cooling water passing through the first radiator 5 flows into the cooling passage 13 at the branch point P3, and flows into the second radiator 6. That is, the cooling water passing through the first radiator 5 flows toward the second radiator 6 at the branch point P3, without going to the confluent point P2, because the second thermostat 22 closes the passage 11 between the branch point P3 and the confluent point P2.

The cooling water passing through the second radiator 6 in the cooling passage 13 flows into the second heat exchanger 4 and the first heat exchanger 3 through the confluent point P6. That is, since the first thermostat 21 closes the bypass passage 14, the cooling water flowing through the confluent point P6 flows into the second heat exchanger 4 and the first heat exchanger 3 without flowing into the bypass passage 14.

The cooling water flowing through the second heat exchanger 4 and the first heat exchanger 3 in the cooling passage 13 flows into the branch passage 12 at the confluent point P4.

The cooling water flowing into the branch passage 12 at the confluent point P4 flows into the circulation passage 11 at the confluent point P2, and is drawn by the water pump 2 through the confluent point P8. That is, the cooling water flowing into the circulation passage 11 at the confluent point P2 flows toward the confluent point P8, without going to the branch point P3, because the second thermostat 22 closes the passage 11 between the branch point P3 and the confluent point P2.

On the other hand, the cooling water flowing into the branch passage 12 at the branch point P1 joins the cooling water flowing from the cooling passage 13 at the confluent point P4, and is drawn by the water pump 2 through the confluent points P2, P8.

On the other hand, the cooling water flowing into the heating passage 15 at the branch point P7 passes the heater core 7, joins the cooling water flowing through the circulation passage 11 at the confluent point P8, and is drawn by the water pump 2.

Thus, in the second mode, cooling water emits heat while passing through the first radiator 5 and the second radiator 6. For this reason, when the temperature of the cooling water is in the middle temperature area, that is when the passenger compartment already has a required temperature by the heating, the temperature of the cooling water is restricted from increasing.

Flow of the cooling water in the third mode is explained specifically with reference to FIG. 2C. In the third mode, the flow of the cooling water flowing out of the water pump 2 passes the engine 1 in the circulation passage 11, and is branched at the branch point P7 into a flow heading to the branch point P1 in the circulation passage 11 and a flow flowing into the heating passage 15.

The cooling water flowing through the circulation passage 11 is further branched at the branch point P1 into a flow heading to the branch point P5 in the circulation passage 11 and a flow flowing into the branch passage 12.

The cooling water flowing through the circulation passage 11 flows into the first radiator 5 at the branch point P5. That is, cooling water flows into the first radiator 5 without flowing into the bypass passage 14, because the first thermostat 21 opens the passage 11 between the branch point P5 and the first radiator 5 and because the first thermostat 21 closes the bypass passage 14.

The cooling water passing through the first radiator 5 is branched at the branch point P3 into a flow heading to the confluent point P2 in the circulation passage 11 and a flow flowing through the cooling passage 13, because the second thermostat 22 opens the passage 11 between the branch point P3 and the confluent point P2.

The cooling water flowing through the circulation passage 11 is drawn into the water pump 2 through the points P2. P8.

On the other hand, the cooling water flowing into the cooling passage 13 at the branch point P3 flows through the second radiator 6. The cooling water passing through the second radiator 6 flows into the second heat exchanger 4 and the first heat exchanger 3 through the confluent point P6. That is, because the first thermostat 21 closes the bypass passage 14, the cooling water reaching the confluent point P6 flows into the second heat exchanger 4 and the first heat exchanger 3 without flowing into the bypass passage 14.

The cooling water passing through the heat exchangers 4, 3 in the cooling passage 13 flows into the branch passage 12 at the confluent point P4.

The cooling water flowing into the branch passage 12 at the confluent point P4 joins the cooling water flowing through the circulation passage 11 at the confluent point P2, and is drawn by the water pump 2 through the confluent point P8.

On the other hand, the cooling water flowing into the branch passage 12 at the branch point P1 joins the cooling water flowing from the cooling passage 13 at the confluent point P4, and is drawn by the water pump 2 through the confluent points P2, P8.

On the other hand, the cooling water flowing into the heating passage 15 at the branch point P7 passes the heater core 7, joins the cooling water flowing in the circulation passage 11 at the confluent point P8, and is drawn by the water pump 2.

Thus, in the third mode, cooling water emits heat while passing through the first radiator 5 and the second radiator 6, so that the temperature of the cooling water is restricted from increasing.

In the second mode, almost all the cooling water passing through the first radiator 5 flows in the cooling passage 13, and passes the second radiator 6, the second heat exchanger 4 and the first heat exchanger 3.

In the third mode, only a part of the cooling water passing through the first radiator 5 flows in the cooling passage 13, and the other cooling water flows through the circulation passage 11 and is drawn into the water pump 2 without flowing through the cooling passage 13.

For this reason, in the third mode, the flow amount of the cooling water flowing through the first radiator 5 increases compared with the second mode. As a result, the heat emitting amount in the first radiator 5 also increases compared with the second mode.

Because the heat emitting amount in the first radiator 5 increases in the third mode compared with the second mode, when the temperature of the cooling water is in the high temperature area, that is when the engine 1 is required to be cooled, the electric parts and the engine 1 can be cooled with reliability.

Concrete example of operation in the second mode (low radiation mode) is explained below. When the cooling water flowing out of the engine 1 has a temperature of 65° C., the cooling water passing through the first radiator 5 has a temperature of about 50° C., the cooling water passing through the second radiator 6 has a temperature of about 30° C., and the cooling water flowing through the first radiator 5 and the second radiator 6 has a flow rate of about 5 L/min.

Concrete example of operation in the third mode is explained below. When the cooling water flowing out of the engine 1 has a temperature of 108° C., the cooling water passing through the first radiator 5 has a temperature of about 100° C., the cooling water passing through the second radiator 6 has a temperature of about 60° C., the cooling water flowing through the first radiator 5 has a flow rate of about 60 L/min, and the cooling water flowing through the second radiator 6 has a flow rate of about 10 L/min.

### Second Embodiment

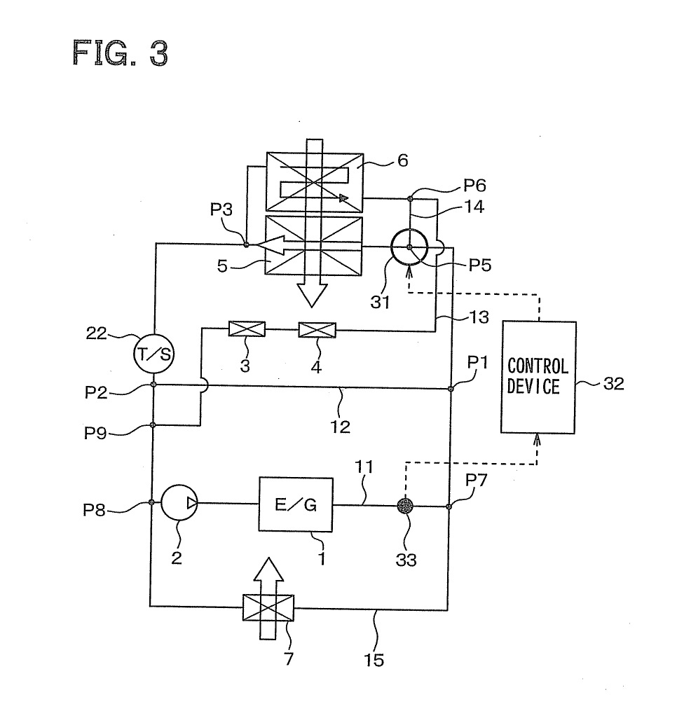

In a second embodiment, as shown in FIG. 3, an electric three-way valve 31 is used in place of the first thermostat 21 of the first embodiment. The three-way valve 31 is arranged at the branch point P5 of the circulation passage 11, and is controlled by a control device 32. A temperature sensor 33 is connected to an inlet side of the control device 32, and is located downstream of the engine 1 and upstream of the first radiator 5, in the circulation passage 11. The sensor 33 detects a temperature of cooling water discharged out of the engine 1.

The control device 32 controls the three-way valve 31 based on a signal output from the sensor 33. Specifically, when the temperature of cooling water detected by the sensor 33 does not reach a predetermined temperature (about 50-70° C.) necessary for heating the passenger compartment, the passage 11 between the branch point P5 and the first radiator 5 is closed and the bypass passage 14 is opened. When the temperature of cooling water detected by the sensor 33 reaches the predetermined temperature necessary for heating the passenger compartment, the passage 11 between the branch point P5 and the first radiator 5 is opened and the bypass passage 14 is closed.

In the first embodiment, the cooing passage 13 is defined to connect the branch point P3 of the circulation passage 11 to the confluent point P4 of the branch passage 12. In the second embodiment, the cooing passage 13 is defined to connect the branch point P3 of the circulation passage 11 to a confluent point P9 of the circulation passage 11. The confluent point P9 is located between the confluent point P2 and the confluent point P8 of the circulation passage 11.

Similar advantages can be obtained in the second embodiment as the first embodiment.

### Third Embodiment

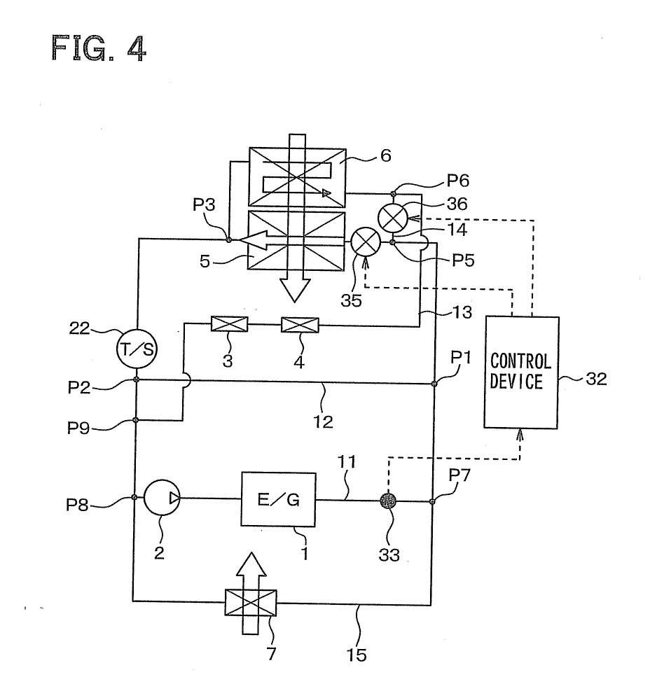

In a third embodiment, as shown in FIG. 4, two electromagnetic valves 35, 36 are used in place of the electric three-way valve 31 of the second embodiment.

The first electromagnetic valve 35 is arranged between the branch point P5 and the first radiator 5 of the circulation passage 11. The second electromagnetic valve 36 is arranged in the bypass passage 14. The first and second electromagnetic valves 35, 36 are controlled by a control device 32.

When the temperature of cooling water detected by the sensor 33 does not reach a predetermined temperature (about 50-70° C.) necessary for heating the passenger compartment, the control device 32 closes the first valve 35 and opens the second valve 36. When the temperature of cooling water detected by the sensor 33 reaches the predetermined temperature necessary for heating the passenger compartment, the control device 32 opens the first valve 35 and closes the second valve 36.

Similar advantages can be obtained in the third embodiment as the first embodiment.

### Fourth Embodiment

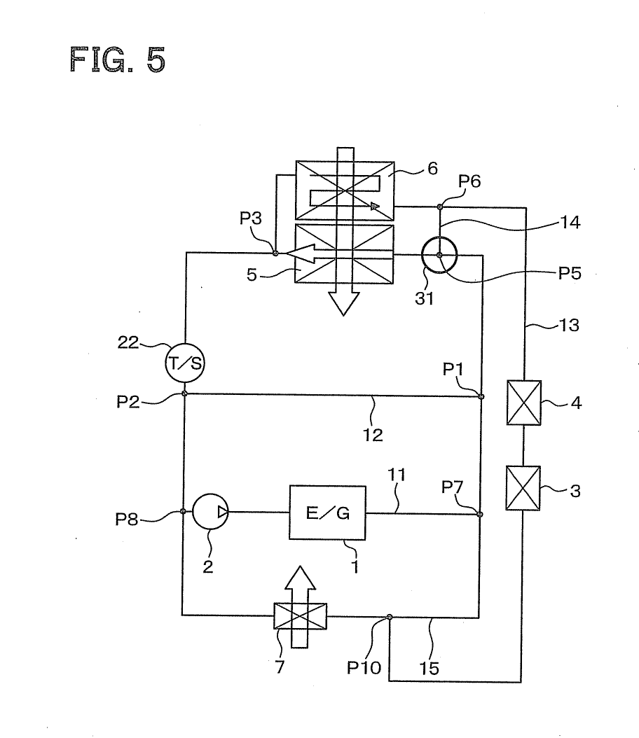

In the second embodiment, the cooing passage 13 is defined to connect the branch point P3 of the circulation passage 11 to the confluent point P9 of the circulation passage 11. In a fourth embodiment, as shown in FIG. 5, the cooing passage 13 is defined to connect the branch point P3 of the circulation passage 11 to a confluent point P10 of the heating passage 15. The confluent point P10 is located upstream of the heater core 7 in the heating passage 15.

The control device 32 and the temperature sensor 33 are omitted in FIG. 5.

Similar advantages can be obtained in the fourth embodiment as the second embodiment.

### Fifth Embodiment

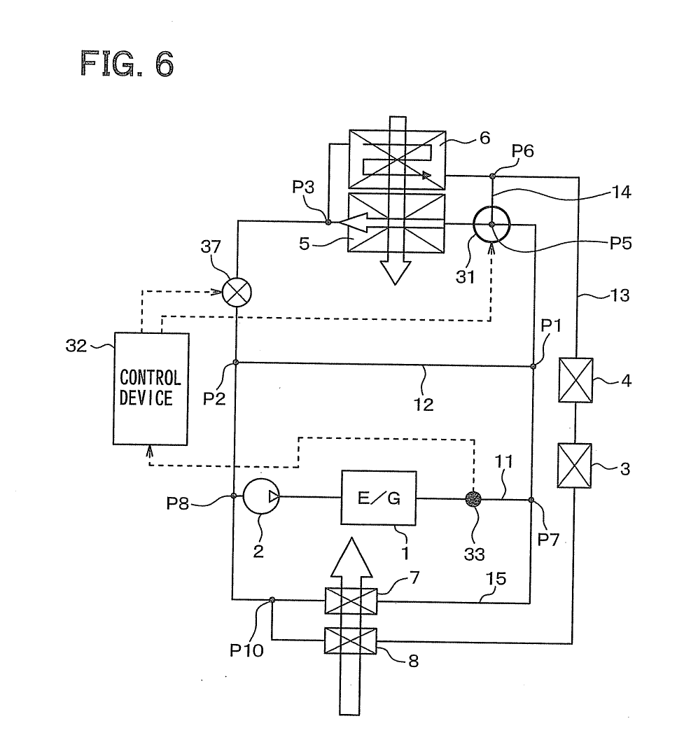

In the fourth embodiment, the confluent point P10 of the cooling passage 3 is located upstream of the heater core 7 in the heating passage 15. In a fifth embodiment, as shown in FIG. 6, the confluent point P10 of the cooling passage 13 is located downstream of the heater core 7 in the heating passage 15.

A second heater core 8 is arranged downstream of the heat exchangers 4, 3 in the cooling passage 13. The second heater core 8 is a heat exchanger for heating in the air-conditioner of the vehicle, and heats air to be sent into the passenger compartment by exchanging heat with cooling water (heat medium).

The second heater core 8 is located upstream of the first heater core 7 in an air flowing direction. Air passing through the second heater core 8 flows into the first heater core 7.

An electromagnetic valve 37 corresponding to an electric valve is used in place of the second thermostat 22 of the first embodiment. The valve 37 is arranged between the branch point P3 and the confluent point P2 in the circulation passage 11, and is controlled by a control device 32.

When the temperature of cooling water detected by the sensor 33 does not reach a predetermined temperature (about 80-100° C.), it is unnecessary to cool the engine 1, and the control device 32 closes the valve 37. When the temperature of cooling water detected by the sensor 33 reaches the predetermined temperature, it is necessary to cool the engine 1, and the control device 32 opens the valve 37.

Similar advantages can be obtained in the fifth embodiment as the fourth embodiment.

### Sixth Embodiment

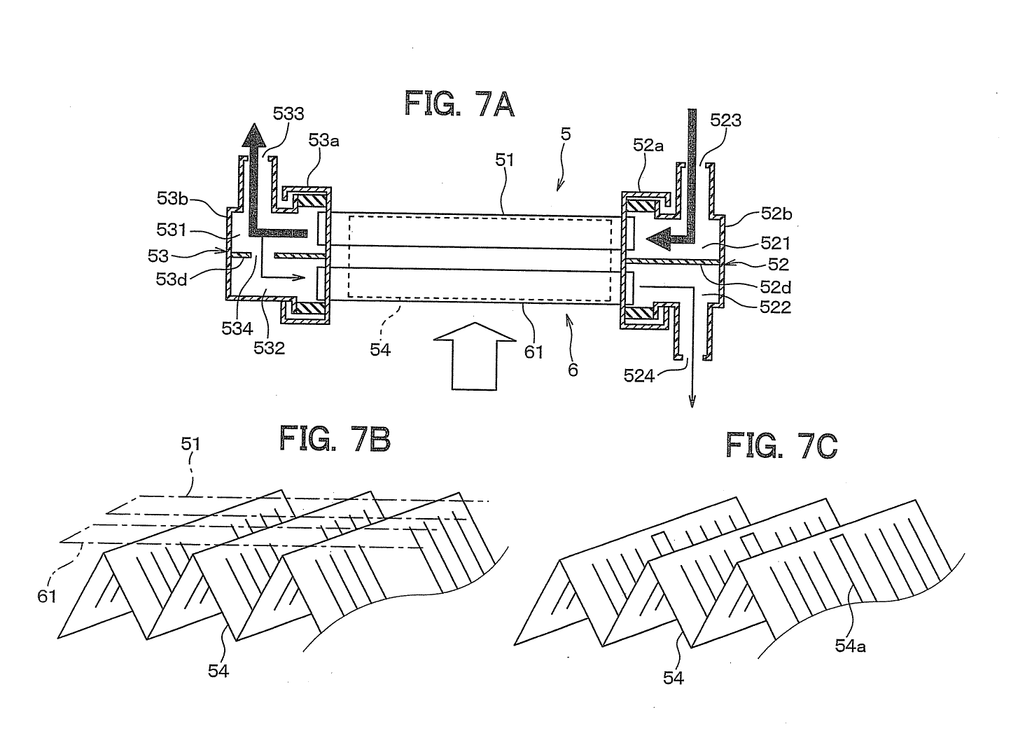

Specific constructions of the first radiator 5 and the second radiator 6 are described in a sixth embodiment, with reference to FIG. 7A.

The first radiator 5 and the second radiator 6 are integrated with each other. The first radiator 5 has a first tube group 51 constructed by plural tubes through which cooling water flows, and the second radiator 6 has a second tube group 61 constructed by plural tubes through which cooling water flows. Each tube is made of aluminum alloy, for example.

The first tube group 51 is located downstream of the second tube group 61 in air flowing direction. The first tube group 51 corresponds to the first radiator 5, and the second tube group 61 corresponds to the second radiator 6.

The integrated radiator 5, 6 has a first tank 52 and a second tank 53. The first tank 52 is located at longitudinal ends of the first and second tube groups 51, 61, and communicate with the first and second tube groups 51, 61. The second tank 53 is located at the other longitudinal ends of the first and second tube groups 51, 61, and communicate with the first and second tube groups 51, 61.

The tank 52, 53 has a plate 52a, 53a and a casing 52b, 53b. An end portion of the tube is inserted into the plate 52a, 53a. The plate 52a, 53a is made of aluminum alloy, and each tube is brazed to the plate 52a, 53a, for example.

The casing 52b, 53b and the plate 52a, 53a define a space in the tank 52, 53. The casing 52b, 53b is made of resin, and the plate 52a, 53 is fixed to the casing 52b, 53b by swaging. A gasket may be interposed between the casing 52b, 53b and the plate 52a, 53a, as a sealing member.

A separator 52d is arranged in the first tank 52, such that inside space of the first tank 52 is separated into a first space 521 and a second space 522. The first space 521 communicates with the first tube group 51, and the second space 522 communicates with the second tube group 61.

The first tank 52 has an inlet 523 that communicates with the first space 521, and an outlet 524 that communicates with the second space 522. Cooling water flows into the first radiator 5 through the inlet 523, and flows out of the second radiator 6 through the outlet 524.

A separator 53d is arranged in the second tank 53, such that inside space of the second tank 53 is separated into a first space 531 and a second space 532. The first space 531 communicates with the first tube group 51, and the second space 532 communicates with the second tube group 61.

The second tank 53 has an outlet 533 that communicates with the first space 531. The separator 53d has a communication port 534 through which the first space 531 and the second space 532 communicate with each other. Cooling water flows out of the first radiator 5 through the outlet 533, and flows into the second radiator 6 through the communication port 534.

As shown in FIG. 7B, a common corrugated fin 54 is arranged between the tubes of the first radiator 5, and is arranged between the tubes of the second radiator 6. The fin 54 promotes heat exchange between cooling water and air.

As shown in FIG. 7C representing a modification example of FIG. 7B, the fin 54 may have a slit 54a at a position between the first tube group 51 and the second tube group 61. Heat exchange between the first radiator 5 and the second radiator 6 is restricted by the slit 54a.

According to the sixth embodiment, a tank that distributes cooling water for the tubes of the first radiator 5 and a tank that gathers cooling water for the tubes of the second radiator 6 are made common with each other. Further, a tank that gathers cooling water for the tubes of the first radiator 5 and a tank that distributes cooling water for the tubes of the second radiator 6 are made common with each other. Therefore, the number of swaging between the casing and the plate can be reduced.

Specifically, swaging between the tubes of the first radiator 5 and the tubes of the second radiator 6 is unnecessary. Therefore, clearance dimension between the tubes of the first radiator 5 and the tubes of the second radiator 6 can be reduced, and whole size of the first radiator 5 and the second radiator 6 can be made smaller in the air flowing direction.

### Seventh Embodiment

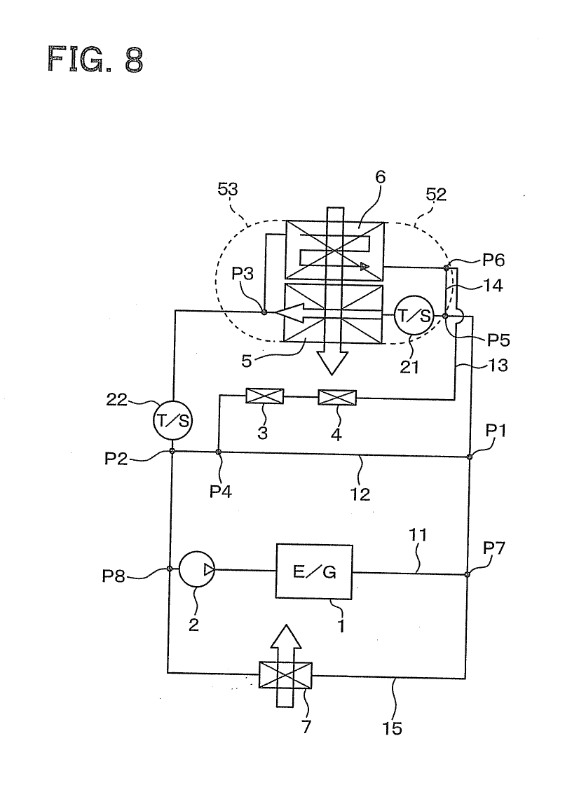

In a seventh embodiment, as shown in FIG. 8, a bypass passage 14 and a first thermostat 21 are arranged in the first tank 52 of the integrated radiator 5, 6 of the sixth embodiment. Thus, tube construction and tube connection operation can be simplified.

Further, the second thermostat 22 may be arranged in the second tank 53 of the integrated radiator 5, 6 of the sixth embodiment.

### Other Embodiment

The cooling system may be applied to a fuel cell vehicle in place of the hybrid vehicle.

Such changes and modifications are to be understood as being within the scope of the present invention as defined by the appended claims.

What is claimed is:

1. A cooling system for a vehicle comprising:
a circulator that circulates heat medium in a heat medium circuit, the heat medium cooling an energy generator of the vehicle;
a cooler that cools electric parts of the vehicle using the heat medium;
a radiator that emits heat of the heat medium to air;
a heat exchanger that heats air to be sent into a passenger compartment of the vehicle by exchanging heat with the heat medium; and
a valve that changes a flow of the heat medium among a plurality of modes based on a temperature of the heat medium, wherein
the plurality of modes include a radiator bypass mode where the heat medium bypasses the radiator and a radiator flow mode where the heat medium flows through the radiator,
the valve changes the flow of the heat medium to have the radiator bypass mode when the temperature of the heat medium is lower than a first predetermined value, and
the valve changes the flow of the heat medium to have the radiator flow mode when the temperature of the heat medium is higher than or equal to the first predetermined value.

2. The cooling system according to claim 1, wherein
the first predetermined value is set in a manner that the radiator bypass mode is selected when it is necessary that the heat exchanger heats air to be sent into the passenger compartment of the vehicle.

3. The cooling system according to claim 1, wherein
the radiator flow mode has a low flow mode and a high flow mode, a flow rate of the heat medium in the radiator being higher in the high flow mode than in the low flow mode,
the valve changes the flow of the heat medium to have the low flow mode when the temperature of the heat medium is higher than or equal to the first predetermined value and when the temperature of the heat medium is lower than a second predetermined value that is higher than the first predetermined value, and
the valve changes the flow of the heat medium to have the high flow mode when the temperature of the heat medium is higher than or equal to the second predetermined value.

4. The cooling system according to claim 3, wherein
the second predetermined value is set in a manner that the radiator flow mode is selected when cooling of the energy generator is necessary.

5. The cooling system according to claim 3, wherein
the radiator includes a first radiator and a second radiator arranged upstream of the first radiator in an air flowing direction,
approximately all of the heat medium passing through the first radiator flows into the second radiator and the cooler when the low flow mode is selected, and
the heat medium passing through the first radiator is branched into a flow flowing into the second radiator and the cooler and a flow bypassing the second radiator and the cooler when the high flow mode is selected.

6. The cooling system according to claim 5, wherein
the first radiator has a first tube group through which the heat medium passes and a first tank space that distributes or gathers the heat medium relative to the first tube group,
the second radiator has a second tube group through which the heat medium passes and a second tank space that distributes or gathers the heat medium relative to the second tube group, and
the first tank space and the second tank space are defined by separating an inside space of a common tank using a separator.

7. The cooling system according to claim 5, wherein
the valve has
a first valve that switches a flow of the heat medium at upstream of the first radiator in a flowing direction of the heat medium, and
a second valve that switches a flow of the heat medium at downstream of the first radiator in the flowing direction of the heat medium.

8. The cooling system according to claim 6, wherein
the valve has
a first valve that switches a flow of the heat medium at upstream of the first radiator in a flowing direction of the heat medium, and
a second valve that switches a flow of the heat medium at downstream of the first radiator in the flowing direction of the heat medium, and
at least one of the first valve and the second valve is arranged in the common tank.

9. The cooling system according to claim 7, wherein
at least one of the first valve and the second valve is a thermostat.

10. The cooling system according to claim 7, wherein
at least one of the first valve and the second valve is an electric valve.

11. The cooling system according to claim 7, wherein
the heat medium circuit has
a circulation passage extending from the first radiator to the circulator by bypassing the second radiator and the cooler; and
a cooling passage branched from the circulation passage, the second radiator and the cooler being arranged in the cooling passage,
the second valve is arranged in the circulation passage, and
the circulation passage has a confluent point located between the second valve and the circulator, and the heat medium passing through the cooing passage joins the circulation passage at the confluent point.

12. The cooling system according to claim 5, wherein
the heat medium circuit has
a circulation passage extending from the first radiator to the circulator by bypassing the second radiator and the cooler;
a cooling passage branched from the circulation passage, the second radiator and the cooler being arranged in the cooling passage; and
a heating passage branched from the circulation passage at a position upstream of the first radiator in the flowing direction of the heat medium,
the heat exchanger is arranged in the heating passage, and
the heating passage has a confluent point located upstream of the heat exchanger in the flowing direction of the heat medium, and the heat medium passing through the cooing passage joins the heating passage at the confluent point.

13. The cooling system according to claim 5, wherein
the heat exchanger has a first heat exchanger and a second heat exchanger arranged upstream of the first heat exchanger in an air flowing direction,
heat medium bypassing the first radiator, the second radiator and the cooler flows into the first heat exchanger, and
heat medium passing through the second radiator and the cooler flows into the second heat exchanger.

14. The cooling system according to claim 13, wherein
the heat medium circuit has
a circulation passage extending from the first radiator to the circulator by bypassing the second radiator and the cooler;
a cooling passage branched from the circulation passage, the second radiator, the cooler and the second heat exchanger being arranged in the cooling passage; and
a heating passage branched from the circulation passage at a position upstream of the first radiator in the flowing direction of the heat medium, wherein
the first heat exchanger is arranged in the heating passage, and
the heating passage has a confluent point located downstream of the first heat exchanger in the flowing direction of the heat medium, and the heat medium passing through the cooing passage joins the heating passage at the confluent point.

15. The cooling system according to claim 11, wherein
the heat medium circuit further has
a bypass passage branched from the circulation passage at a position upstream of the first radiator in the flowing direction of the heat medium,
the cooler is located in the cooling passage at a position downstream of the second radiator in the flowing direction of the heat medium, and
the bypass passage joins the cooling passage at a position downstream of the second radiator and upstream of the cooler in the flowing direction of the heat medium.
